(19) United States
(12) Patent Application Publication
(10) Pub. No.: US 2012/0280632 A1
(43) Pub. Date: Nov. 8, 2012

(54) LIGHT EMITTING DIODE DRIVING APPARATUS AND METHOD FOR DRIVING THE SAME

(76) Inventors: Wooseok Kim, Gyeonggi-do (KR); Hyo-Sang Youn, Gyeonggi-do (KR); Bumkil Lee, Seoul (KR)

(21) Appl. No.: 13/464,446

(22) Filed: May 4, 2012

(30) Foreign Application Priority Data
May 4, 2011 (KR) 10-2011-0042708

(51) Int. Cl. H05B 37/02

(52) U.S. Cl. 315/192

(57) ABSTRACT

According to example embodiments, a light emitting diode driving includes a power converter configured to convert a power supply voltage into a lamp driving power supply voltage in response to a voltage control signal, first and second light emitting diode strings supplied with the lamp driving power supply voltage, a first slave driver circuit configured to detect headroom voltages of the second light emitting diode strings and to output a first slave headroom error signal in response to the detected headroom voltages, and a master driver circuit configured to detect headroom voltages of first light emitting diode strings and to output a master headroom error signal in response to the detected headroom voltages of the first light emitting diode strings. The master driver circuit may be configured to output the voltage control signal in response to the master and the first slave headroom error signals.

### CROSS-REFERENCE TO RELATED APPLICATIONS

This application claims priority under 35 U.S.C §119 to Korean Patent Application No. 10-2011-0042708, filed on May 4, 2011, the entire disclosure of which is incorporated by reference herein.

### BACKGROUND

Example embodiments relate to a light emitting diode driving device and/or a method of driving the same.

An electronic device may include a display device as a user interface. As the display device, a flat panel display device may be used for a light and low-power electronic device. The flat panel display device may include an OLED (Organic Light Emitting Diode) device, an LCD (Liquid Crystal Display) device, an FED (Field Emission Display) device, a VFD (Vacuum Fluorescent Display) device, a PDP (Plasma Display Panel) device, and the like.

Among the flat panel display devices, LCD devices may include a backlight to provide light to a panel. A low-power, slim, and eco-friendly light emitting diode (LED) may be used as a backlight.

### SUMMARY

Example embodiments relate to a light emitting diode driving device and/or a method of driving the same.

According to example embodiments of inventive concepts, a light emitting diode driving device includes a power converter configured to convert a power supply voltage into a lamp driving power supply voltage in response to a voltage control signal, a plurality of first and second light emitting diode strings supplied with the lamp driving power supply voltage, a first slave driver circuit configured to detect headroom voltages of the second light emitting diode strings and to output a first slave headroom error signal in response to the detect headroom voltages of the second light emitting diode strings, a master driver circuit configured to detect headroom voltages of first light emitting diode strings and to output a master headroom error signal in response to the detected headroom voltages of the first light emitting diode strings. The master drive circuit is configured to output the voltage control signal in response to the master headroom error signal and the first slave headroom error signal.

The master driver circuit may be configured to output the voltage control signal as a sum of the master headroom error signal and the first slave headroom error signal.

The first slave driver circuit may include a first slave headroom controller configured to detect a lowest voltage of the headroom voltages detected from the second light emitting diode strings and to output the first slave headroom error signal as corresponding to the detected lowest headroom voltage from the second light emitting diode strings.

The first slave headroom controller may include a slave lowest voltage detector configured to detect the lowest voltage of the detected headroom voltages of the second light emitting diode strings, and a slave amplifier configured to output the first slave headroom error signal corresponding to a difference between a first slave reference voltage and the lowest voltage of the detected headroom voltage of the second light emitting diode strings.

The master driver circuit may include a master headroom controller configured to detect a lowest voltage of the headroom voltages detected from the first light emitting diode strings and to output a master headroom error signal corresponding to the detected lowest voltage of the first light emitting diode strings, and a converter controller configured to output the voltage control signal having a voltage level corresponding to a sum of the first slave headroom error signal and the master headroom error signal.

The master headroom controller includes a master lowest voltage detector configured to detect headroom voltages of the first light emitting diode strings and to detect a master lowest voltage of the detected headroom voltages, and a master amplifier configured to output the master headroom error signal corresponding to a difference between the master lowest voltage and a master reference voltage.

The light emitting diode driving device may further include a second slave driver circuit configured to detect headroom voltages of a plurality third light emitting diode strings supplied with the lamp driving power supply voltage and to output a second slave headroom error signal corresponding to one of the detected headroom voltages, and the converter controller is configured to output the voltage control signal having a voltage level corresponding to a sum of the first and second slave headroom error signals and the master headroom error signal.

The master driver circuit may include a first current controller configured to generate a first reference voltage corresponding to a brightness setting voltage input from the exterior; and first current drivers configured to drive the first light emitting diode strings, respectively, and the first slave driver circuit may include a second current controller configured to generate a second reference voltage corresponding to the brightness setting voltage, and second current drivers configured to drive the second light emitting diode strings, respectively.

The light emitting diode driving device may further include second and third slave driver circuits, wherein one end of each of the first light emitting diode strings is connected in common with one of a plurality of channel terminals of the master driver circuit and one of a plurality of channel terminals of the second slave driver circuit, one end of each of the second light emitting diode strings is connected in common with one of a plurality of channel terminals of the first slave driver circuit and one of a plurality of channel terminals of the third slave driver circuit, and the other ends of the first and second light emitting diode strings are connected with the lamp driving power supply voltage.

Each of the master driver circuit and the first to third slave driver circuits may be an integrated circuit chip.

According to example embodiments of inventive concepts, a light emitting diode driving device includes a plurality of light emitting diode strings and a driver circuit configured to drive the plurality of light emitting diode strings. The driver circuit includes a current controller configured to generate a reference voltage corresponding to a brightness setting voltage input from the exterior, and a plurality of current drivers each corresponding to the plurality of light emitting diode strings and configured to drive a corresponding light emitting diode string in response to the reference voltage.

The current controller is configured to output the reference voltage as equal to one of a brightness reference voltage and the brightness setting voltage.

The current controller is configured to generate the reference voltage as equal to the brightness setting voltage when the brightness setting voltage is lower than a desired voltage.

The current controller is configured to generate the reference voltage as equal to the brightness reference voltage when the brightness setting voltage is identical to or higher than the desired voltage.

According to example embodiments of inventive concepts, a light emitting diode driving device includes a power converter configured to convert a power supply voltage into a lamp driving power supply voltage in response to a voltage control signal, and a plurality of light emitting diode strings supplied with the lamp driving power supply voltage. Each of one ends of the light emitting diode strings is connected in common with one of a plurality of channels of a master driver circuit and one of a plurality of channel terminals of a slave driver circuit. The slave driver circuit is configured to detect headroom voltages of the plurality of light emitting diode strings and to output a slave headroom error signal in response to the detected headroom voltages. The master driver circuit is configured to detect headroom voltages of the plurality of light emitting diode strings and to output a master headroom error signal in response to the detected headroom voltages. The master driver circuit is configured to output the voltage control signal in response to the master and slave headroom error signals.

The plurality of channel terminals of the master driver circuit has specific numbers from 1 to Q (Q being a positive integer) and the plurality of channel terminals of the slave driver circuit has specific numbers from 1 to Q, and numbers of channel terminals of the master and slave driver circuits connected in common with one of the light emitting diode strings are different.

According to example embodiments of inventive concepts, a light emitting diode driving method includes converting a power supply voltage into a lamp driving power supply voltage in response to a voltage control signal; detecting headroom voltages of first light emitting diode strings supplied with the lamp driving power supply voltage to output a master headroom error signal in response to the detected headroom voltages; and detecting headroom voltages of second light emitting diode strings supplied with the lamp driving power supply voltage to output a slave headroom error signal in response to the detected headroom voltages, outputting the voltage control signal in response to the master headroom error signal and the first slave headroom error signal.

According to example embodiments, a light emitting diode device includes at least one LED group, each including a plurality of light emitting diode strings connected in parallel, a driver circuit, and a power converter. The driver circuit is configured to detect headroom voltages from the plurality of light emitting diode stings in the at least one LED group, and the driver circuit is configured to output a control signal based on the detected headroom voltages of the plurality of light emitting diode strings in the at least one LED group. The power converter is configured to receive the control signal and adjust a lamp driving supply voltage supplied to the at least one LED group.

The at least one LED group may further include a master LED group and first LED group. The driver circuit may include a master driver circuit and a first slave driver circuit. The first slave driver circuit may be configured to generate a first slave headroom error signal, based on comparing a first slave reference voltage to a headroom voltage detected from one of the plurality of light emitting diode strings in the first LED group, and output the first slave headroom error signal to the master driver circuit. The master driver circuit may be configured to generate a master headroom error signal, based on comparing a master reference voltage to a headroom voltage detected from one of the plurality of light emitting diode strings in the master LED group, and the master driver circuit may be configured to generate the control signal based on combining the first slave headroom error signal and the master headroom error signal.

The power converter may be configured to convert a power supply voltage into the lamp driving power supply voltage in response to the voltage control signal. The driver circuit may include at least one current controller configured to receive a bright setting voltage and output a current driving voltage based on a comparison between the brightness setting voltage and the power supply voltage. The driver circuit may further include a plurality of current drivers and each current driver may be configured to receive the current driving voltage and drive one of the plurality of light emitting diode strings in response to the current driving voltage.

The driver circuit may further include a master driver circuit and a first slave driver circuit. One end of each of the plurality of light emitting diode strings in the one of the at least one LED groups may be connected in common with one of a plurality of channel terminals of the master driver circuit and one of a plurality of channel terminals of the first slave driver circuit.

According to example embodiments, a display device may include a display panel connected to a backlight. The backlight may include at least one of the foregoing light emitting diode driving devices.

### BRIEF DESCRIPTION OF THE FIGURES

The above and other features and advantages of inventive concepts will become apparent from the following description with reference to the following figures, wherein like reference numerals refer to like parts throughout the various figures unless otherwise specified. The drawings are not necessarily to scale, emphasis instead being placed upon illustrating the principles of inventive concepts. In the drawings:

FIG. 1 is a diagram illustrating a display device including a light emitting driving device according to example embodiments of inventive concepts.

FIG. 2 is a block diagram illustrating a light emitting diode driving device in FIG. 1.

FIG. 3 is a block diagram illustrating a master headroom controller in FIG. 2.

FIG. 4 is a block diagram illustrating a slave headroom controller in FIG. 2.

FIG. 5 is a block diagram illustrating a display device including a light emitting diode driving device according to example embodiments of inventive concepts.

FIG. 6 is a block diagram illustrating a light emitting diode driving device in FIG. 5.

FIG. 7 is a circuit diagram illustrating a current controller and a current driver in FIG. 6 according to example embodiments of inventive concepts.

FIG. 8 is a block diagram illustrating a light emitting diode driving device, to which a brightness control function described in FIGS. 5 to 7 is applied, according to example embodiments of inventive concepts.

FIG. 9 is a block diagram illustrating a light emitting diode driving device according to example embodiments of inventive concepts.

FIG. 10 is a block diagram illustrating a light emitting diode driving device according to example embodiments of inventive concepts.

### DETAILED DESCRIPTION

Example embodiments of inventive concepts are described more fully hereinafter with reference to the accompanying drawings, in which some example embodiments of inventive concepts are shown. Example embodiments of inventive concepts may, however, be embodied in many different forms and should not be construed as limited to the embodiments set forth herein. Rather, these embodiments are provided so that this disclosure will be thorough and complete, and will fully convey the scope of example embodiments of inventive concepts to those skilled in the art. In the drawings, the size and relative sizes of layers and regions may be exaggerated for clarity. Like numbers refer to like elements throughout. Accordingly, the description of like elements may be omitted to avoid duplication.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

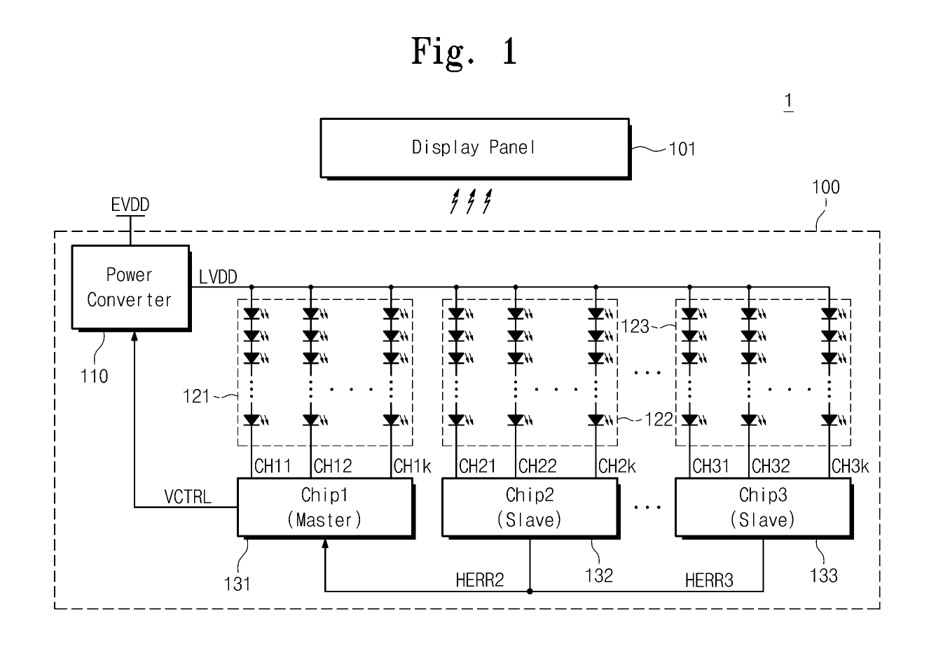

FIG. 1 is a diagram illustrating a display device including a light emitting driving device according to example embodiments of inventive concepts.

A display device 1 may include a display panel 101 and a light emitting diode device 100. The display panel 101 may be a display device (e.g., a liquid crystal display) necessitating a backlight.

The light emitting diode device 100 may operate as a backlight of the display panel 101. Further, the light emitting diode device 100 may be used at applications such as an LED illumination, an LED advertisement panel, and the like, but example embodiments are not limited thereto. The light emitting diode device 100 may include a power converter 110, a plurality of light emitting diode groups 121 to 123, and a plurality of driver circuits 131 to 133 each corresponding to the plurality of light emitting diode groups 121 to 123. In FIG. 1, there are illustrated three light emitting diode groups 121 to 123 and three driver circuits 131 to 133. However, example embodiments of inventive concepts are not limited thereto.

The power converter 110 may convert an externally input power supply voltage EVDD into a lamp driving power supply voltage LVDD. The lamp driving power supply voltage LVDD may have a voltage level sufficient to drive light emitting diodes in the plurality of light emitting diode groups 121 to 123.

Each of the plurality of light emitting diode groups 121 to 123 may include a plurality of light emitting diode strings, each of which includes a plurality of light emitting diodes connected in series.

Each of the driver circuits 131 to 133 may be formed of an integrated circuit chip. Below, the driver circuit 131 may be referred to as a master driver circuit, and the driver circuits 132 to 133 may be referred to as a slave driver circuit. The master driver circuit 131 may be configured to drive light emitting diode strings within the light emitting diode group 121. The master driver circuit 131 may detect headroom voltages of one ends CH11 to CH1k of the light emitting diode strings. Depending upon the detected headroom voltages and slave headroom error signals HERR2 to HERR3 from the slave driver circuits 132 to 133, the master driver circuit 131 may output a control signal VCTRL to the power converter 110 such that the lamp driving power supply voltage LVDD is adjusted.

The slave driver circuit 132 may be configured to drive light emitting diode strings within the light emitting diode group 122. The slave driver circuit 132 may detect headroom voltages of one ends CH21 to CH2k of the light emitting diode strings to output the slave headroom error signal HERR2 corresponding to the detected headroom voltages.

The slave driver circuit 133 may be configured to drive light emitting diode strings within the light emitting diode group 123. The slave driver circuit 133 may detect headroom voltages of one ends CH31 to CH3k of the light emitting diode strings to output the slave headroom error signal HERR3 corresponding to the detected headroom voltages.

A stable operation of light emitting diodes and a reduction (and/or minimization) of power consumption may be accomplished by detecting headroom voltages of one ends of light emitting diode strings and controlling the lamp driving power supply voltage LVDD, generated by the power converter 110, according to the detected headroom voltages.

The master driver circuit 131 may generate the control signal VCTRL for controlling a level of the lamp driving power supply voltage LVDD generated by the power converter 110, depending upon the detected headroom voltages and slave headroom error signals HERR2 to HERR3 from the slave driver circuits 132 to 133.

A size of the display panel 101 may be proportional to the number of light emitting diodes of the light emitting diode driving device 100. If the display panel 101 becomes bigger, the number of light emitting diodes provided at the light emitting diode driving device 100 may increase. Since the number of light emitting diodes capable of being connected with each of the driver circuits 131 to 133 is limited, an increase in the number of light emitting diodes may be accomplished by increasing the number of driver circuits 131 to 133. Although the number of driver circuits increases, the light emitting diode driving device 100 according to example embodiments of inventive concepts may include one power converter 110, and the lamp driving power supply voltage LVDD generated by the power converter 110 may be controlled by providing slave headroom error signals HERR2 to HERR3 from the slave driver circuit 132 to 133 to the master driver circuit 131. Although the number of driver circuits increases, it is possible to reduce an increase in the number of components.

While FIG. 1 illustrates a light emitting diode device 100 including one power converter 110, example embodiments are not limited thereto. Driver circuits and power converters may be provided according to design considerations. For example, one power converter may be provided when the light emitting diode driving device 100 necessitates four driver circuits. Two power converters may be provided when the light emitting diode driving device 100 necessitates eight driver circuits. In case of the latter case, the number of master driver circuits may be controlled to be identical to that of power converters. It is possible to reduce (and/or minimize) an area of the light emitting diode driving device 100 by including fewer power converters than the number of driver circuits. Accordingly, the cost of production may be reduced.

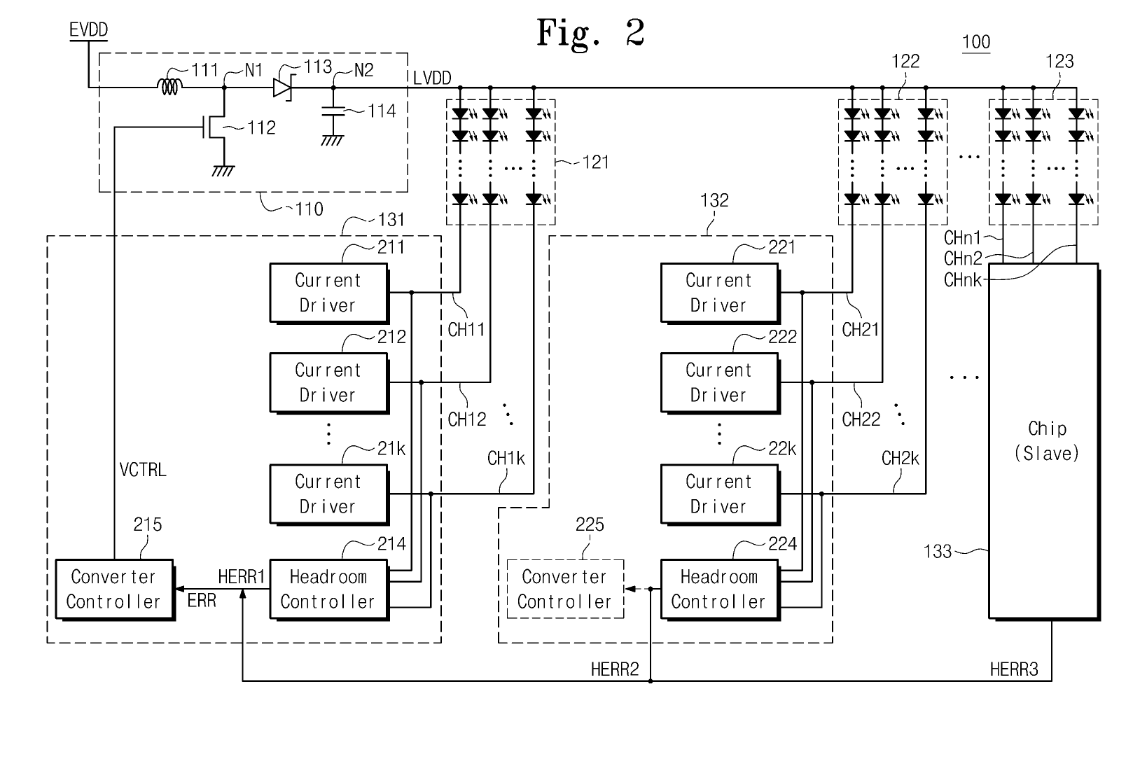

FIG. 2 is a block diagram illustrating a light emitting diode driving device in FIG. 1.

Referring to FIG. 2, a power converter 110 may include an inductor 111, an NMOS transistor 112, a diode 113, and a capacitor 114. The inductor 111 may be connected between an externally provided power supply voltage EVDD and a node N1. The NMOS transistor 112 may be connected between the node N1 and a ground voltage. A gate of the NMOS transistor 112 may be connected to receive a voltage control signal VCTRL from a converter controller 215 within a master driver circuit 131. The diode 113 may be connected between nodes N1 and N2. The diode 113 may be a Schottky diode. The capacitor 114 may be connected between the node N2 and the ground voltage. The lamp driving power supply voltage LVDD of the node N2 may be supplied to light emitting diode strings within the light emitting diode groups 121 to 123.

The power converter 110 may be configured to convert an externally provided power supply voltage EVDD into the lamp driving power supply voltage LVDD. In particular, a level of the lamp driving power supply voltage LVDD may be adjusted according to the voltage control signal VCTRL applied to the gate of the NMOS transistor 112.

The master driver circuit 131 may include current drivers 211 to 21k each corresponding to light emitting diode strings in the light emitting diode group 121, a master headroom controller 214, and a converter controller 215. Each of the current drivers 211 to 21k may be configured to control a current flowing via a corresponding light emitting diode string. The master headroom controller 214 may be configured to detect headroom voltages of one ends CH11 to CH1k of light emitting diode strings in the light emitting diode group 121 and to generate a master headroom error signal HERR1 according to the detected headroom voltages.

The current drivers 211 to 21k of the master driver circuit 131 may control the amount of current of each of the light emitting diode strings such that a current needed to stably operate light emitting diodes of the light emitting diode strings flows. At this time, the lamp driving power supply voltage LVDD may be supplied such that a headroom voltage of each of light emitting diode strings is maintained to be higher than a reference voltage (e.g., to be a possible low voltage).

The master headroom controller 214 may detect the lowest voltage of headroom voltages of one ends CH11 to CH1k of light emitting diode strings to compare the detected headroom voltage with a reference voltage. The master headroom controller 214 may generate a master headroom error signal HERR1 depending upon a difference between the detected headroom voltage and the reference voltage.

Current drivers 211 to 21k of a slave driver circuit 132 may control the amount of current of each of light emitting diode strings such that a current needed to stably operate light emitting diodes of the light emitting diode strings flows. At this time, the lamp driving power supply voltage LVDD may be supplied such that a headroom voltage of each of light emitting diode strings is maintained to be higher than a reference voltage (e.g., to be a possible low voltage).

A headroom controller 224 of the slave driver circuit 132 may detect the lowest voltage of headroom voltages of light emitting diode strings to compare the detected headroom voltage with the reference voltage. The headroom controller 224 may generate a slave headroom error signal HERR2 depending upon a difference between the detected headroom voltage and the reference voltage. The slave driver circuit 133 may be configured the same as the slave driver circuit 132, and may generate a slave headroom error signal HERR3.

A converter controller 215 may be configured to generate an error signal ERR obtained by adding the master headroom error signal HERR1 from the master headroom controller 214 and slave headroom error signals HERR2 and HERR3 from the driver circuits 132 and 133 respectively. Although not shown in FIG. 2, the converter controller 215 may include a circuit (e.g., a capacitor) which is configured to charge the error signal ERR sufficiently.

For ease of a fabrication process, the master and slave driver circuits 131 to 133 may be configured to have the same structure. A slave headroom error signal HERR2 output from the headroom controller 224 in the slave driver circuit 132 may be provided to the master driver circuit 131 via an output terminal (not shown). Although the slave driver circuits 132 may include a converter controller 225, the converter controller 225 may not used for operating of the slave driver circuits 132.

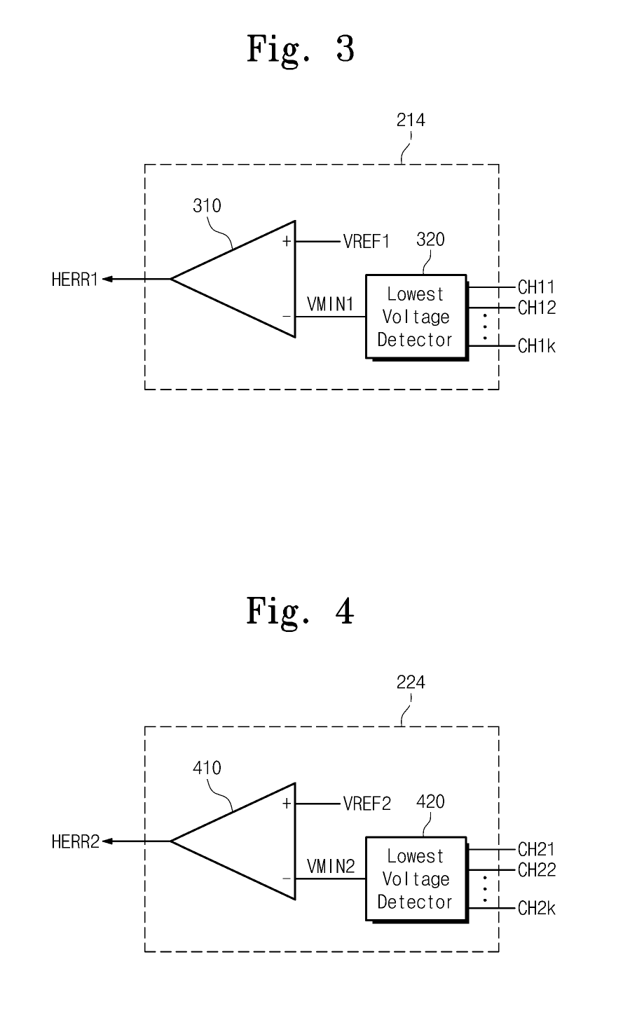

FIG. 3 is a block diagram illustrating a master headroom controller in FIG. 2.

Referring to FIG. 3, a master headroom controller 214 may include an amplifier 310 and a lowest voltage detector 320. The lowest voltage detector 320 may be connected with one ends CH11 to CH1k of light emitting diode strings within a light emitting diode group 121 in FIG. 2. The lowest voltage detector 320 may detect the lowest voltage of headroom voltages of the one ends CH11 to CH1k of the light emitting diode strings within the light emitting diode group 121. The lowest voltage detector 320 may output the detected voltage as a minimum voltage VMIN1. The amplifier 310 may compare a master reference voltage VREF1 and the minimum voltage VMIN1 to output a master headroom error signal HERR1 as a comparison result.

FIG. 4 is a block diagram illustrating a slave headroom controller in FIG. 2.

Referring to FIG. 4, a slave headroom controller 224 may include an amplifier 410 and a lowest voltage detector 420. The lowest voltage detector 420 may be connected with one ends CH21 to CH2k of light emitting diode strings within a light emitting diode group 122 in FIG. 2. The lowest voltage detector 420 may detect the lowest voltage of headroom voltages of the one ends CH21 to CH2k of the light emitting diode strings within the light emitting diode group 122. The lowest voltage detector 420 may output the detected voltage as a minimum voltage VMIN2. The amplifier 410 may compare a slave reference voltage VREF2 and the minimum voltage VMIN2 to output a slave headroom error signal HERR2 as a comparison result.

A slave headroom controller within each of remaining slave driver circuits in FIG. 2 may be configured the same as that in FIG. 4.

Minimum voltages needed to drive light emitting diode strings within a light emitting diode group may differentiate due to fabrication process differences of the master driver circuit 131 and the slave driver circuit 132. The master reference voltage VREF1 of the master headroom controller 214 and the slave reference voltage VREF2 of the slave headroom controller 224 may be determined on the basis of minimum voltages capable of driving corresponding light emitting diode groups.

If the minimum voltage VMIN1 of the master headroom controller 214 is lower in level than the master reference voltage VREF1, a lamp driving power supply voltage LVDD may increase such that the minimum voltage VMIN1 increases. If the minimum voltage VMIN2 of the slave headroom controller 224 is lower in level than the slave reference voltage VREF2, the lamp driving power supply voltage LVDD may increase such that the minimum voltage VMIN2 increases.

Returning to FIG. 2, a converter controller 215 may generate a voltage control signal VCTRL in response to an error signal ERR corresponding to a sum of the master headroom error signal HERR1 and slave headroom error signals HERR2 to HERR3. Each of the master and slave headroom error signals HERR1 to HERR3 may be a current signal. The voltage control signal VCTRL may be output according to a current amount corresponding to the error signal ERR being the added result. Accordingly, the converter controller 215 may output an optimum voltage control signal VCTRL considering headroom voltages detected by the master driver circuit 131 and headroom voltages detected by the slave driver circuits 132 to 133. A power converter 110 may output a lamp driving power supply voltage LVDD having a minimum voltage capable of driving all light emitting diode strings within light emitting diode groups 121 to 123 in response to the voltage control signal VCTRL.

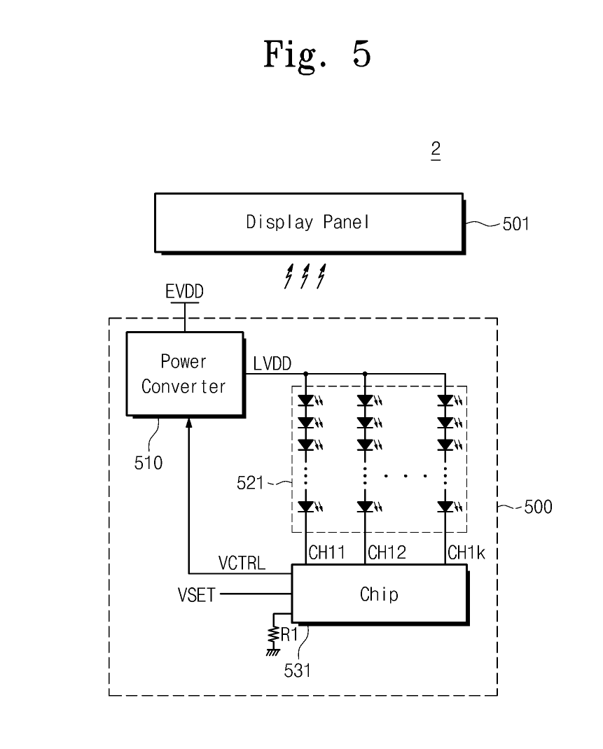

FIG. 5 is a block diagram illustrating a display device including a light emitting diode driving device according to example embodiments of inventive concepts.

Referring to FIG. 5, a display device 2 may include a display panel 501 and a light emitting diode driving device 500. The light emitting diode driving device 500 may include a power converter 510, a light emitting diode group 521, and a driver circuit 531.

The light emitting diode group 521 may include a plurality of light emitting diode strings, each of which has a plurality of light emitting diodes connected in series.

The driver circuit 531 may receive a brightness setting voltage VSET. Further, the driver circuit 531 may be connected with a resistor R1. When the brightness setting voltage VSET is higher in level than a given voltage (e.g., a power supply voltage), the driver circuit 531 may drive the light emitting diode group 521 to have a brightness corresponding to a desired (and/or alternatively predetermined) reference voltage. When the brightness setting voltage VSET is lower than the given voltage (e.g., power supply voltage), the driver circuit 531 may drive the light emitting diode group 521 so as to have a brightness corresponding to the brightness setting voltage VSET.

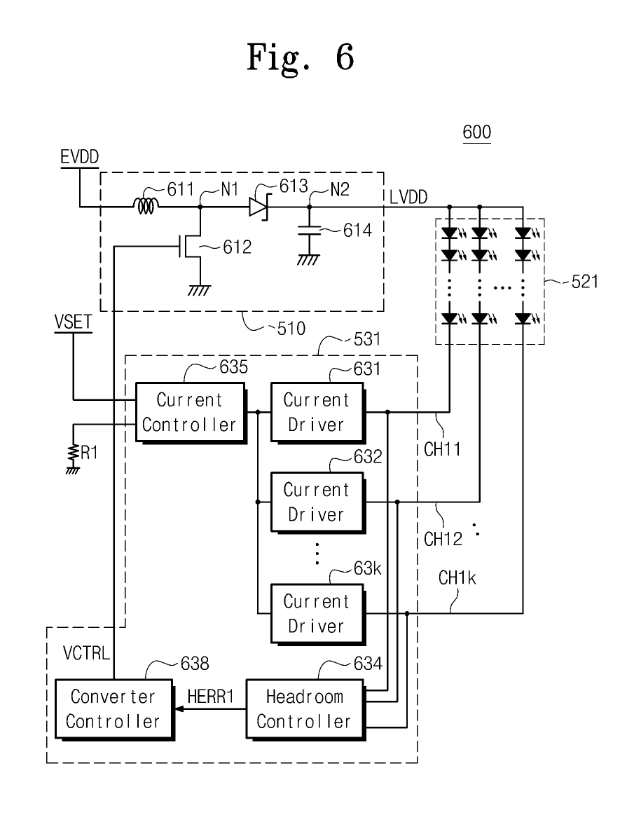

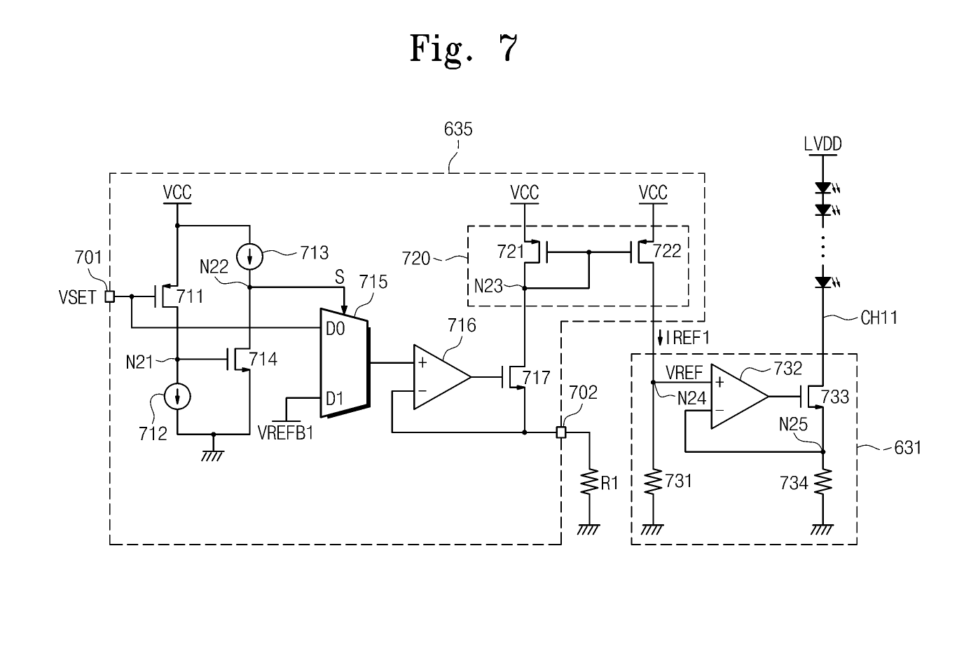

FIG. 6 is a block diagram illustrating a light emitting diode driving device in FIG. 5.

Referring to FIG. 6, a power converter 510 of a light emitting diode driving device 600 may be configured the same as that in FIG. 2. A driver circuit 531 may be configured to be similar to that in FIG. 2 except for a current controller 635. Each of current drivers 631 to 63k may control a current for driving the light emitting diode group 521 in response to a reference voltage VREF provided from the current controller 635.

FIG. 7 is a circuit diagram illustrating a current controller and a current driver in FIG. 6 according to example embodiments of inventive concepts.

Referring to FIG. 7, a current controller 635 may include the first terminal 701, the second terminal 702, a PMOS transistor 711, current sources 712 and 713, NMOS transistors 714 and 717, a multiplexer 715, an amplifier 716, and a current mirror 720.

The PMOS transistor 711 may be connected between a power supply voltage VCC and a node N21 and may have a gate connected to receive a brightness setting voltage VSET provided via the first terminal 701. The current source 712 may be connected between the node N21 and a ground voltage. The current source 713 may be connected between the power supply voltage VCC and a node N22. The NMOS transistor 714 may be connected between the node N22 and the ground voltage and may have a gate connected with the node N21. The multiplexer 715 may include the first input terminal D0 connected with the bright setting voltage VSET, the second input terminal D1 connected with a brightness reference voltage VREFB1, and an output terminal. The amplifier 716 may include input terminals each connected with an output of the multiplexer 715 and the second terminal 702 and an output terminal. The NMOS transistor 717 may be connected between a node N23 and the second terminal 702 and may have a gate connected with the output of the amplifier 716. A resistor R1 may be connected between the second terminal 702 and the ground voltage.

The current mirror 720 may include PMOS transistors 721 and 722. The PMOS transistor 721 may be connected between the power supply voltage VCC and the node N23 and may have a gate connected with the node N23. The PMOS transistor may be connected between the power supply voltage VCC and a node N24 and may have a gate connected with the node N23.

When the brightness setting voltage VSET input via the first terminal 701 is lower than the power supply voltage VCC, the current controller 635 may output a reference voltage IREF1 corresponding to the brightness setting voltage VSET. When the brightness setting voltage VSET is identical to or higher than the power supply voltage VCC, the current controller 635 may output a reference current IREF1 corresponding to the brightness reference voltage VREFB1.

The current driver 631 may include an amplifier 732, an NMOS transistor 733, and resistors 731 and 734. The amplifier 732 may include input terminals each connected with nodes N24 and N25 and an output terminal. The NMOS transistor 733 may be connected between one end CH11 of a corresponding light emitting diode string and the node N25 and may have a gate connected with an output of the amplifier 732. The resistor 731 may be connected between the node N24 and the ground voltage, and the resistor 734 may be connected between the node N25 and the ground voltage. The current driver 631 may be configured such that a current corresponding to a voltage of the node N24 flows via a light emitting diode string.

If the power supply voltage VCC is applied to the first terminal 701, the PMOS transistor 711 may be turned off and the NMOS transistor 714 may be turned off. This may enable the node N22 to be set to the power supply voltage VCC, that is, a high level. In response to a selection signal S being a voltage signal of the node N22, the multiplexer 715 may output the brightness reference voltage VREFB1 input via the second input terminal D1 as its output. A reference current IREF1 corresponding to the brightness reference voltage VREFB1 may flow via the node N24 by the amplifier 716, the NMOS transistor 717, and the current minor 720. Accordingly, the current controller 635 and the current driver 631 may drive a light emitting diode string so as to have a brightness corresponding to the brightness reference voltage VREFB1.

If the brightness setting voltage VSET lower in level than the power supply voltage VCC is applied to the first terminal 701, the PMOS transistor 711 may be turned on and the NMOS transistor 714 may be turned on. This means that the node N22 goes to a low level. In response to a selection signal S being a voltage signal of the node N22, the multiplexer 715 may output the brightness setting voltage VSET input via the first input terminal D0 as its output. A reference current IREF1 corresponding to the brightness setting voltage VSET may flow via the node N24 by the amplifier 716, the NMOS transistor 717, and the current minor 720. Accordingly, the current controller 635 and the current driver 631 may drive a light emitting diode string so as to have a brightness corresponding to the brightness setting voltage VSET.

The light emitting diode driving device 500 may control the brightness of a light emitting diode group 521 by preparing the first and second terminals 701 and 701 at the driver circuit 531 and setting a brightness setting voltage VSET input to the first terminal 701 and a resistance of the resistor R1 connected with the second terminal 702.

In particular, in the event that a display panel is designed to display a three-dimensional image, there may be many limitations to control brightness in the PWM (pulse width modulation) manner. In the event that a current supplied to each of light emitting diode strings is adjusted according to the PWM manner to control the brightness in a three-dimensional image display manner in which a right-eye image and a left-eye image are alternately output, it is difficult to normally display a three-dimensional image. The inventive concept may enable the brightness to be adjusted easily by setting of a brightness setting voltage VSET. At this time, a level of the brightness setting voltage VSET may be made by a driver circuit (not shown) in a display panel 501.

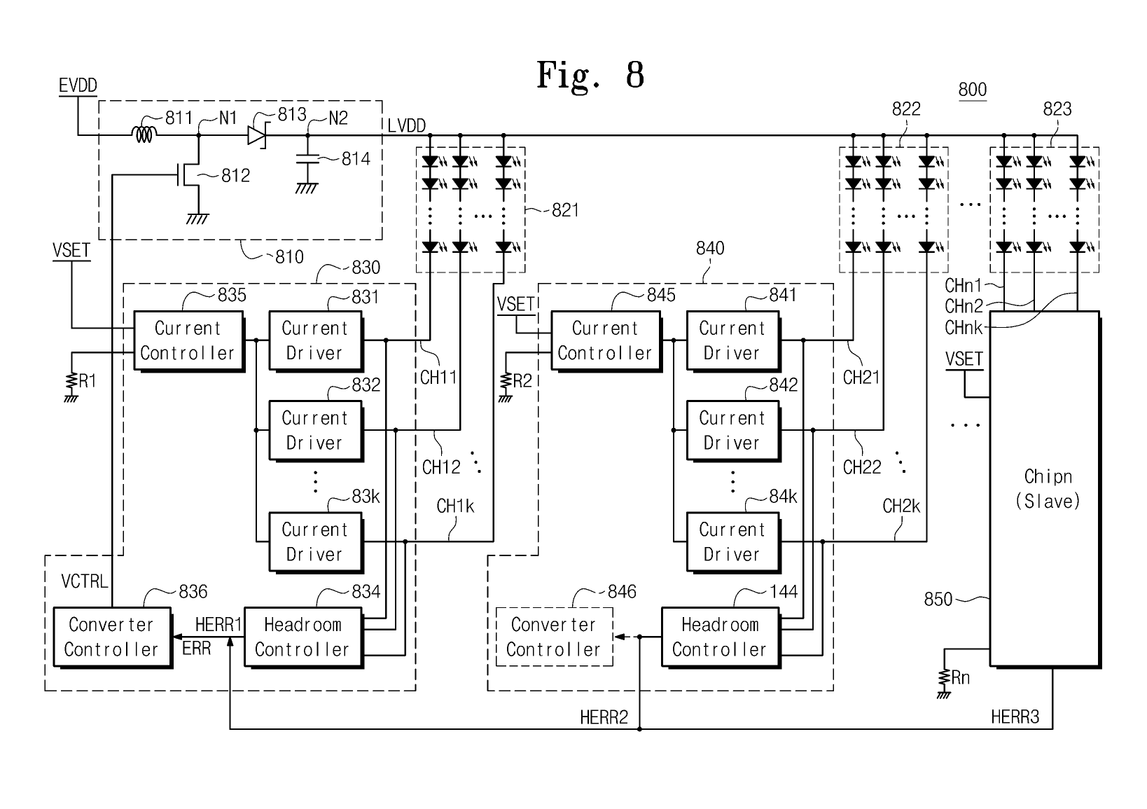

FIG. 8 is a block diagram illustrating a light emitting diode driving device, to which a brightness control function described in FIGS. 5 to 7 is applied, according to example embodiments of inventive concepts.

A light emitting diode driving device in FIG. 8 may be similar to that in FIG. 2 except a master driver circuit 830 further includes a current controller 835 connected with current drivers 831 to 83k and a slave driver circuit 840 further includes a current controller 845 connected with current drivers 841 to 84k.

The current drivers 831 to 83k and the current controller 835 within the master driver circuit 830 and the current drivers 841 to 84k and the current controller 845 within the slave driver circuit 840 may operate the same as those in FIGS. 6 and 7, and description thereof is thus omitted. For ease of a fabrication process, the master and slave driver circuits 830 to 850 may be configured to have the same structure. Although the slave driver circuits 840 may include a converter controller 846, the converter controller 846 may not used for operating of the slave driver circuits 840.

With the light emitting diode driving device 800, the brightness of light emitting diode groups 821 to 823 may be controlled by setting a brightness setting voltage VSET and resistance values of a resistor R1, connected with the master driver circuit 830, and resistors R2 to Rn connected with slave driver circuits 840 to 850.

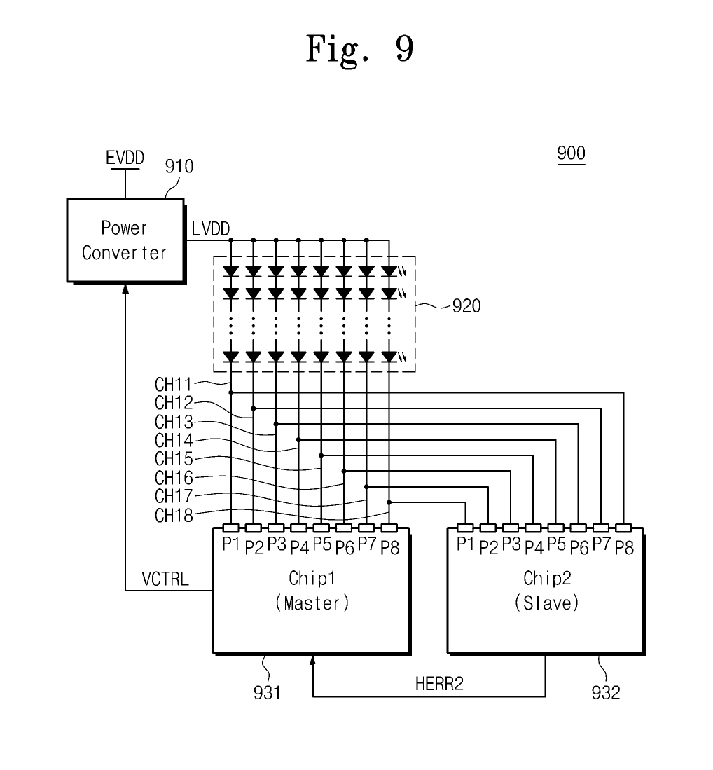

FIG. 9 is a block diagram illustrating a light emitting diode driving device according to example embodiments of inventive concepts.

Referring to FIG. 9, a light emitting diode driving device 900 may include a power converter 910, a light emitting diode group 920, a master driver circuit 931, and a slave driver circuit 932. The power converter 910, the master driver circuit 931, and the slave driver circuit 932 may be configured the same as those in FIG. 1.

The light emitting diode driving device 900 in FIG. 9 may be configured to drive a light emitting diode group 920 formed of large current light emitting diodes using the master driver circuit 931 being a low current driver circuit and the slave driver circuit 932. One light emitting diode string may be driven at the same time by the master driver circuit 931 and the slave driver circuit 932. For example, in the event that the light emitting diode group 920 is formed of eight light emitting diode strings, that is, the first to eighth light emitting diode strings, one end CH11 of the first light emitting diode string in the light emitting diode group 920 may be connected with the first channel terminal P1 of the master driver circuit 931 and the eighth channel terminal P8 of the slave driver circuit 932.

One end CH12 of the second light emitting diode string in the light emitting diode group 920 may be connected with the second channel terminal P2 of the master driver circuit 931 and the seventh channel terminal P7 of the slave driver circuit 932. One end CH13 of the third light emitting diode string in the light emitting diode group 920 may be connected with the third channel terminal P3 of the master driver circuit 931 and the sixth channel terminal P6 of the slave driver circuit 932. One end CH14 of the fourth light emitting diode string in the light emitting diode group 920 may be connected with the fourth channel terminal P4 of the master driver circuit 931 and the fifth channel terminal P5 of the slave driver circuit 932. One end CH15 of the fifth light emitting diode string in the light emitting diode group 920 may be connected with the fifth channel terminal P5 of the master driver circuit 931 and the fourth channel terminal P4 of the slave driver circuit 932. One end CH16 of the sixth light emitting diode string in the light emitting diode group 920 may be connected with the sixth channel terminal P6 of the master driver circuit 931 and the third channel terminal P3 of the slave driver circuit 932. One end CH17 of the seventh light emitting diode string in the light emitting diode group 920 may be connected with the seventh channel terminal P7 of the master driver circuit 931 and the second channel terminal P2 of the slave driver circuit 932. One end CH18 of the eighth light emitting diode string in the light emitting diode group 920 may be connected with the eighth channel terminal P8 of the master driver circuit 931 and the first channel terminal P1 of the slave driver circuit 932. The other end of each of the first to eighth light emitting diode strings in the light emitting diode group 920 may be connected to receive a lamp driving power supply voltage LVDD output from a power converter 910.

With the configuration in FIG. 9, as compared with one end of a light emitting diode string is connected with two channel terminals of the same driver circuits, it is possible to reduce (and/or minimize) a screen spot phenomenon due to a process distribution between the master driver circuit 931 and the slave driver circuit 932.

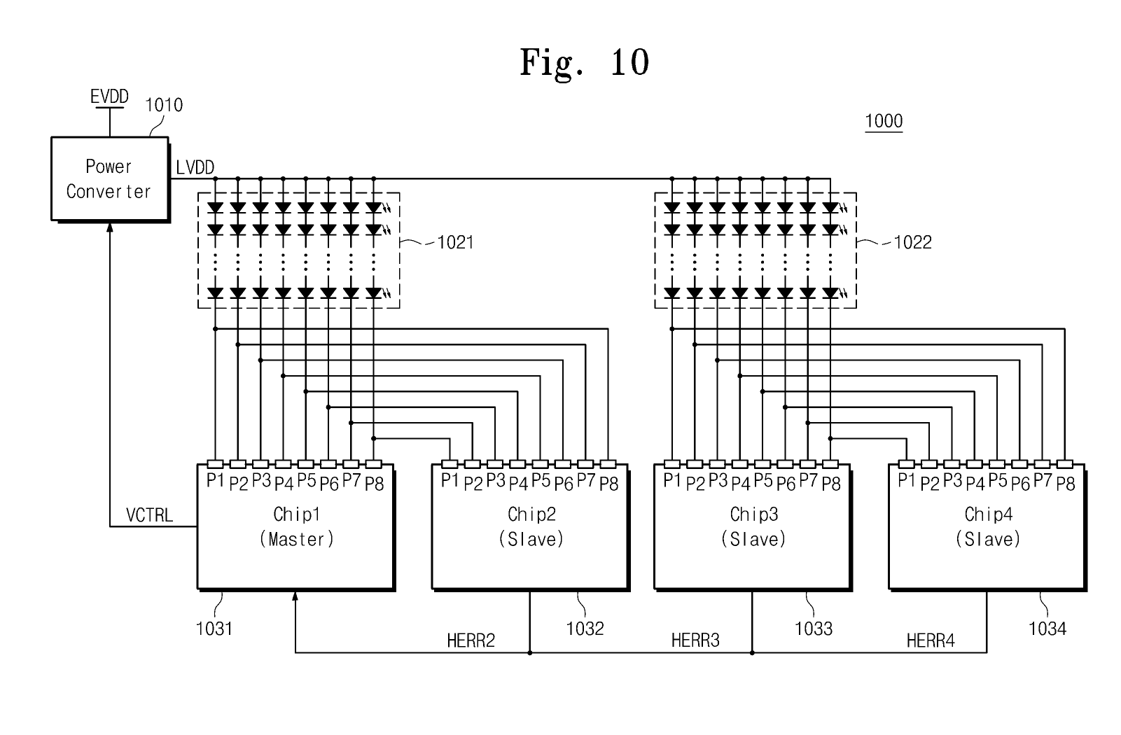

FIG. 10 is a block diagram illustrating a light emitting diode driving device according to example embodiments of inventive concepts.

A light emitting diode driving device 1000 may include a power converter 1010, two light emitting diode groups 1021 and 1022, and four driver circuits 1031 to 1034. The driver circuit 1031 may be a master driver circuit, and each of remaining driver circuits 1032 to 1034 may be a slave driver circuit.

Light emitting diode strings in the light emitting diode group 1021 may be connected with the master driver circuit 1031 and the slave driver circuit 1032, and light emitting diode strings in the light emitting diode group 1022 may be connected with the slave driver circuit 1033 and the slave driver circuit 1034.

One light emitting diode string may be connected in common with different channel terminals of two driver circuits as described in FIG. 9.

While FIGS. 9 and 10 illustrate a case where one light emitting diode string is connected in common with two driver circuits, example embodiments are not limited thereto. However, one light emitting diode string can be connected in common with three or more driver circuits.

With the above description, although the number of light emitting diodes increases, one power converter may be used within a light emitting diode driving device. This makes it possible to reduce a cost increase and to simplify brightness control of the light emitting diode driving device. In the event that the light emitting diode driving device includes a plurality of driver chips, it is possible to reduce (and/or prevent) a screen quality from being lowered due to a characteristic difference between the driver chips.

While some example embodiments have been particularly shown and described, it will be understood by one of ordinary skill in the art that variations in form and detail may be made therein without departing from the spirit and scope of the claims.

What is claimed is:

1. A light emitting diode driving device comprising:
a power converter configured to convert a power supply voltage into a lamp driving power supply voltage in response to a voltage control signal;
a plurality of first and second light emitting diode strings supplied with the lamp driving power supply voltage;
a first slave driver circuit configured to detect headroom voltages of the second light emitting diode strings and to output a first slave headroom error signal in response to the detected headroom voltages of the second light emitting diode strings,
a master driver circuit configured to detect headroom voltages of the first light emitting diode strings and to output a master headroom error signal in response to the detected headroom voltages of the first light emitting diode strings,
the master driver circuit being configured to output the voltage control signal in response to the master headroom error signal and the first slave headroom error signal.

2. The light emitting diode driving device of claim 1, wherein the master driver circuit is configured to output the voltage control signal as a sum of the master headroom error signal and the first slave headroom error signal.

3. The light emitting diode driving device of claim 1, wherein the first slave driver circuit includes:
a first slave headroom controller configured to detect a lowest voltage of the headroom voltages detected from the second light emitting diode strings and to output the first slave headroom error signal as corresponding to the detected lowest headroom voltage from the second light emitting diode strings.

4. The light emitting diode driving device of claim 3, wherein the first slave headroom controller includes:
a lowest voltage detector configured to detect the lowest voltage of the detected headroom voltages of the second light emitting diode strings; and
a slave amplifier configured to output the first slave headroom error signal based on a difference between a first slave reference voltage and the lowest voltage of the detected headroom voltage of the second light emitting diode strings.

5. The light emitting diode driving device of claim 1, wherein the master driver circuit includes:
a master headroom controller configured to detect a lowest voltage of the detected headroom voltages of the first light emitting diode strings and to output a master headroom error signal,
the master headroom error signal corresponding to the detected lowest voltage of the first light emitting diode strings; and
a converter controller configured to output the voltage control signal having a voltage level corresponding to a sum of the first slave headroom error signal and the master headroom error signal.

6. The light emitting diode driving device of claim 5, wherein the master headroom controller includes:
a master lowest voltage detector configured to detect headroom voltages of the first light emitting diode strings and to detect a master lowest voltage of the detected headroom voltages; and
a master amplifier configured to output the master headroom error signal based on a difference between the master lowest voltage and a master reference voltage.

7. The light emitting diode driving device of claim 5, further comprising:
a second slave driver circuit configured to detect headroom voltages of a plurality third light emitting diode strings supplied with the lamp driving power supply voltage and to output a second slave headroom error signal corresponding to one of the detected headroom voltages from the plurality of third light emitting diode strings, and
wherein the converter controller is configured to output the voltage control signal as a voltage level corresponding to a sum of the first and second slave headroom error signals and the master headroom error signal.

8. The light emitting diode driving device of claim 1, wherein
the master driver circuit includes,
a first current controller configured to generate a first reference voltage,
the first reference voltage corresponding to a brightness setting voltage input from the exterior, and
first current drivers configured to drive the first light emitting diode strings, respectively, and
the first slave driver circuit includes,
a second current controller configured to generate a second reference voltage,
the second reference voltage corresponding to the brightness setting voltage, and
second current drivers configured to drive the second light emitting diode strings, respectively.

9. The light emitting diode driving device of claim 1, further comprising:
second and third slave driver circuits, wherein
one end of each of the first light emitting diode strings is connected in common with one of a plurality of channel terminals of the master driver circuit and one of a plurality of channel terminals of the second slave driver circuit,
one end of each of the second light emitting diode strings is connected in common with one of a plurality of channel terminals of the first slave driver circuit and one of a plurality of channel terminals of the third slave driver circuit, and
the other ends of the first and second light emitting diode strings are connected with the lamp driving power supply voltage.

10. The light emitting diode driving device of claim 9, wherein each of the master driver circuit and the first to third slave driver circuits is an integrated circuit chip.

11. A light emitting diode driving device comprising:
a plurality of light emitting diode strings; and
a driver circuit configured to drive the plurality of light emitting diode strings, the driver circuit including,
a current controller configured to generate a reference voltage based on a brightness setting voltage input from the exterior, and
a plurality of current drivers,
each of the plurality of current drivers corresponding to the plurality of light emitting diode strings and configured to drive a corresponding light emitting diode string in response to the reference voltage.

12. The light emitting diode driving device of claim 11, wherein
the current controller is configured to output the reference voltage as equal to one of a brightness reference voltage and the brightness setting voltage.

13. The light emitting diode driving device of claim 12, wherein the current controller is configured to generate the reference voltage as equal to the brightness setting voltage when the brightness setting voltage is lower than a desired voltage.

14. The light emitting diode driving device of claim 13, wherein the current controller is configured to generate the reference voltage as equal to the brightness reference voltage when the brightness setting voltage is identical to or higher than the desired voltage.

15. A light emitting diode driving device comprising:
a power converter configured to convert a power supply voltage into a lamp driving power supply voltage in response to a voltage control signal;
a plurality of light emitting diode strings supplied with the lamp driving power supply voltage,
each of one ends of the light emitting diode strings is connected in common with one of a plurality of channel terminals of a master driver circuit and one of a plurality of channel terminals of a slave driver circuit,
the slave driver circuit being configured to detect headroom voltages of the plurality of light emitting diode strings and to output a slave headroom error signal in response to the detected headroom voltages, the master driver circuit being configured to detect headroom voltages of the plurality of light emitting diode strings and to output a master headroom error signal in response to the detected headroom voltages, and
the master driver circuit being configured to output the voltage control signal in response to the master and slave headroom error signals.

16. The light emitting diode driving device of claim 15, wherein
the plurality of channel terminals of the master driver circuit have specific numbers from 1 to Q (Q being a positive integer),
the plurality of channel terminals of the slave driver circuit have specific numbers from 1 to Q, and
wherein numbers of channel terminals of the master and slave driver circuits connected in common with one of the light emitting diode strings are different.

17. A light emitting diode driving method comprising:
converting a power supply voltage into a lamp driving power supply voltage in response to a voltage control signal;
detecting headroom voltages of first light emitting diode strings supplied with the lamp driving power supply voltage to output a master headroom error signal in response to the detected headroom voltages; and
detecting headroom voltages of second light emitting diode strings supplied with the lamp driving power supply voltage to output a slave headroom error signal in response to the detected headroom voltages,
outputting the voltage control signal in response to the master headroom error signal and the first slave headroom error signal.

18. A light emitting diode driving device comprising:
at least one LED group, each LED group including a plurality of light emitting diode strings connected in parallel;
a driver circuit,
the driver circuit configured to detect headroom voltages from the plurality of light emitting diode strings in the at least one LED group, and
the driver circuit configured to output a control signal based on the detected headroom voltages of the plurality of light emitting diode strings in the at least one LED group; and
a power converter configured to receive the control signal and adjust a lamp driving supply voltage supplied to the at least one LED group.

19. The light emitting diode driving device of claim 18, wherein
the at least one LED group includes a master LED group and a first LED group,
the driver circuit includes a master driver circuit and a first slave driver circuit,
the first slave driver circuit is configured to generate a first slave headroom error signal, based on comparing a first slave reference voltage to a headroom voltage detected from one of the plurality of light emitting diode strings in the first LED group, and output the first slave headroom error signal to the master driver circuit,
the master driver circuit is configured to generate a master headroom error signal, based on comparing a master reference voltage to a headroom voltage detected from one of the plurality of light emitting diode strings in the master LED group, and
the master driver circuit is configured to generate the control signal, based on combining the first slave headroom error signal and the master headroom error signal.

20. The light emitting diode driving device of claim 18, wherein
the power converter is configured to convert a power supply voltage into the lamp driving power supply voltage in response to the voltage control signal,
the driver circuit includes at least one current controller configured to receive a brightness setting voltage and output a current driving voltage based on a comparison between the brightness setting voltage and the power supply voltage,
the driver circuit further includes a plurality of current drivers,
each current driver being configured to receive the current driving voltage and drive one of the plurality of light emitting diode strings in response to the current driving voltage.

21. The light emitting diode driving device of claim 18, wherein
the driver circuit includes a master driver circuit and a first slave driver circuit, and
one end of each of the plurality of the light emitting diode strings in the one of the at least one LED groups is connected in common with one of a plurality of channel terminals of the master driver circuit and one of a plurality of channel terminals of the first slave driver circuit.

22. A display device comprising:
a display panel connected to a backlight,
the backlight including at least one light emitting diode driving device according to claim 18.
